(19) United States
(12) Patent Application Publication
(10) Pub. No.: US 2006/0258336 A1
(43) Pub. Date: Nov. 16, 2006

(54) Apparatus an method to store and forward voicemail and messages in a two way radio

(76) Inventors: Michael Sajor, Milford, NJ (US); Dale Hartzell, Boulder, CO (US); Brian Marquette, Longmont, CO (US); Charles Corfield, Boulder, CO (US); Swavek Skret, Boulder, CO (US)

Correspondence Address: CHRISTOPHER J. KULISH, ESQ, HOLLAND & HART LLP, P. O. BOX 8749, DENVER, CO, 80201-8749, US

(21) Appl. No.: 11/301,582

(22) Filed: Dec. 13, 2005

Related U.S. Application Data
(60) Provisional application No. 60/593,130, filed on Dec. 14, 2004.

(51) Int. Cl. H04M 11/10

(52) U.S. Cl. 455/413

(57) ABSTRACT

A system to receive, transmit, and store messages using 2-way radio or push to talk system includes monitoring the network for an activation signal and providing an indication over the network that the system is ready to receive the message. Once received, the system replays the message on confirmation of the user's identity.

### RELATED APPLICATIONS

The present application claims the benefit of earlier filed provisional patent application 60/593,130, titled “APPARATUS AND METHOD TO STORE AND FORWARD VOICEMAIL AND MESSAGES IN A Two WAY RADIO COMMUNICATION SYSTEM,” filed Dec. 14, 2005, incorporated herein by reference as if set out in full.

### FIELD OF THE INVENTION

The present invention relates to voicemail and message storage and forwarding and, more particularly, to voicemail and message storage and forwarding in a radio communication system.

### BACKGROUND OF THE INVENTION

In conventional telephone networks, when a called party is unavailable, the calling party is routed to a voicemail system that records and stores the calling party's message. The voicemail system sends a signal to the called party to indicate the called party has a voicemail message ready for retrieval. The called party can call into the voicemail system and retrieve previously stored messages.

While this system works well for conventional telephone calls, one of the challenges with using two-way radio or other push-to-talk (PTT) services is the situation where the called party does not answer the call. PTT and radio users do not have ready access to such voice mail systems.

To overcome the lack of a voicemail system similar to conventional telephone networks, current voicemail technology for two-way radio or PTT requires installation of a special voice storage card on each and every device. The use of a voice storage card is not a centralized, network-based system, but rather requires extensive modification of each and every radio unit deployed on the network to provide local voice storage functions on the device. This current solutions have many drawbacks. One drawback of the voice storage card is that messages are only available on the unit where left. The voice storage cards cannot currently be independently accessed from alternative sources such as other radios, telephones, or the like. This tends to cause a radio and PTT system where ownership of the unit is restricted to an individual entity. This is a non-economical solution with limited scalability. An additional drawback is that the installation, maintenance, and lifecycle management costs for additional hardware on every radio increases.

Finally, while functional, the system limits versatility because messages are left on a particular device for a particular user, the device can no longer be used in a “pool” situation otherwise messages left on a particular radio for a particular user may not ever be recovered, let alone promptly. Thus, to function properly, the radio must be assigned to a particular user. Moreover, urgent messages may be missed if the radio is returned for repairs or the like.

Another drawback of current solutions includes the fact that the system require the users to operate inconvenient menu systems to address the radio of interest for leaving a message. These menus, containing perhaps hundreds of signaling protocol addresses, may require hundreds of button clicks to traverse, making the system inherently unusable.

These highlight a few problems associated with conventional messaging solutions on two-way radio or PTT devices. Against this background, it would be desirous to develop an improved voicemail and messaging storage and forwarding system usable with radio or other PTT services that did not require extensive modifications to existing radios or the like.

### SUMMARY OF THE INVENTION

To attain the advantages of and in accordance with the purpose of the present invention a method for recording and storing messages in a radio network is provided. The method begins with providing an activation signal from the radio network to the communication hub. On receipt of the activation signal, the communication hub indicates it is ready to receive the message. The message is sent from the radio network to the communication hub and stored for later retrieval by the appropriate person.

The present invention further provides a method to retrieve stored messages. Further, identification of the user is requested and confirmed. Once the identity is confirmed, the mail box is accessed and the message transmitted to the user.

The present invention further provides an apparatus to allow users of a radio network to leave messages for other users of the radio network. The apparatus includes a radio gateway to connect the radio network and a communication hub. The communication hub has a voice enabled speech platform for receiving and transmitting messages, and a memory for storing messages from users to other users. The communication hub monitors the radio network for an activation signal and receives, transmits, or stores messages after receipt of the activation signal.

The present invention further provides a computer program product having a computer usable medium having computer readable code embodied therein for receiving, transmitting, and storing voice messages between users of a radio network. The computer usable medium includes modules to perform the required functions including a recording and playback module configured to record and playback messages, an activation module configured to receive and recognize an activation signal, and an indicating module configured to indicate that recording and playback module is ready to record or playback the message. The activation module causes the indicating module to indicate when the activation signal is received and recognized. A memory module stores messages.

The foregoing and other features, utilities and advantages of the invention will be apparent from the following more particular description of a preferred embodiment of the invention as illustrated in the accompanying drawings.

### BRIEF DESCRIPTION OF THE DRAWINGS

The accompanying drawings, which are incorporated in and constitute a part of this specification, illustrate some preferred embodiments of the invention and, together with the description, explain the goals, advantages and principles of the invention.

FIG. 1 provides a functional block diagram of one potential voicemail system;

FIG. 2 provides a functional block diagram of one potential radio gateway;

FIG. 3 provides a flowchart reflective of leaving a message using the system of FIG. 1; and

FIG. 4 provides a flowchart reflective of retrieving a message using the system of FIG. 2.

### DETAILED DESCRIPTION

The present invention will be described in relation to a 2-way radio system. One of ordinary skill in the art will recognize on reading the disclosure that the present invention could be used with any PTT service. Also, the present invention will be explained with relation to a radio to radio connection, but one of ordinary skill in the art will understand that the present invention could be used with a particular frequency or channel of operation, on multiple frequencies or channels of operation, with particular user groups of radios, or the like.

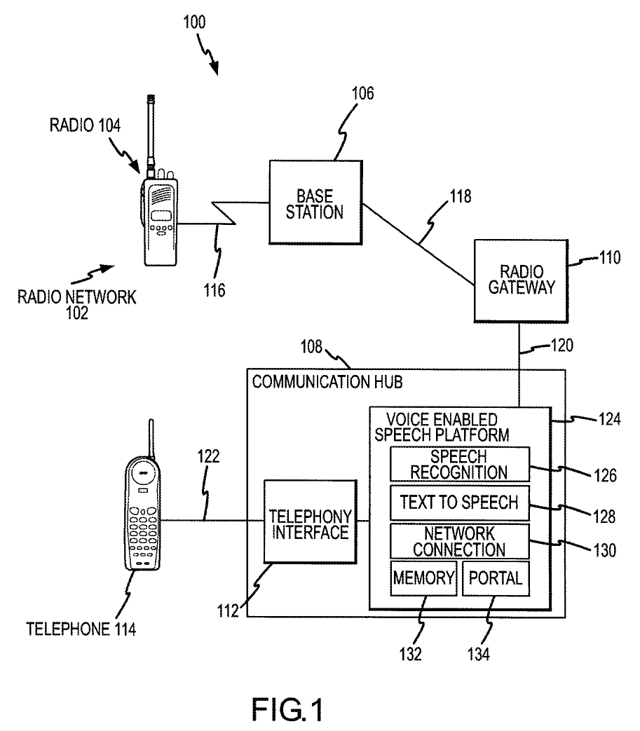

Referring now to FIG. 1, a voicemail system 100 is shown. Voice mail system 100 includes a radio network 102 with one or more mobile devices 104, such as radios, person to person telephones, walkie talkies, or the like, connected to base stations 106. As used herein, mobile device is used generically for two-way radios, push-to-talk devices, walkie talkies, person to person telephones, and the like. Mobile devices 104 may incorporate telephony connections, such as, for example, cellular telephones having both telephony communication capability as well as person to person radio communication. Mobile devices excludes devices with only telephony communication ability. Mobile devices 104 and base stations 106 operate according to radio network protocols for person to person or person to group communication. Mobile devices 104 and base stations 106 may operate on single or multiple channels.

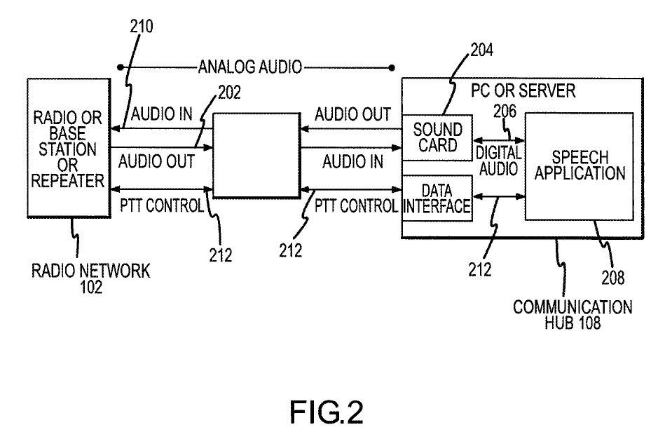

Radio network 102 is connected to a communication hub 108 through a radio gateway 110. Communication hub 108 can be a server, personal computer, or the like. Communication hub 108 is generally known in the art and will only be explained with reference to the present invention. Details regarding radio gateway 110 can be found in U.S. patent application Ser. No. 10/906,393, titled “METHOD AND APPARATUS TO ALLOW Two WAY RADIO USERS TO ACCESS VOICE-ENABLED APPLICATIONS,” filed Feb. 17, 2005, co-pending and co-owned, and incorporated herein by reference as if set out in full. For completeness, however, radio gateway 110 is shown in more detail in FIG. 2. Radio gateway 110 receives communication signals from radio network 102, which signals may originate from either mobile device 104, base station 106, a repeater, or the like, and converts those signals into a format usable by communication hub 108. For example, voice signals 202 from radio network 102 may be converted by a speech recognition engine or sound card 204 to a signal 206 usable by a processor or speech application 208 in communication hub 108. Radio gateway 110 sends communication signals 210 in the form of audio from communication hub 108 to radio network 102 as well. For example, to transmit over radio network 102, radio gateway 110 would provide a signal 212 over the radio network simulating the pushing of the talk button on a radio. Signal 212 may be bi-directional so a communication hub 108 cannot, for example, interrupt a user of mobile device 102. Also, for example, an audio signal generated by, for example, a text-to-speech engine or the sound card 204 may broadcast the signal over radio network 102. Moreover, while shown separate, radio gateway 110 may be incorporated into either base station 106 or communication hub 108 as a matter of design choice.

Communication hub 108 optionally may have a telephony interface 112 connected to conventional telephones 114, such as the cellular telephone shown. Mobile device 104 or radio 104 is connected to base station 106 via a radio communication protocol data link 116, base station 106 is connected to radio gateway 110 by suitable connection, wireless or wired.

Communication hub 108 has routines, modules, and/or processors contained in a voice enabled speech platform 124 to enable speech recognition engines 126 and text to speech engines 128. Voice enabled speech platform 124 could be integrated in communication hub 108 accessible by communication hub 108 via a network connection 130, such as, for example, the Internet, a LAN, a WAN, a WiFi network, an Ethernet, the World Wide Web, or the like. Communication hub 108 also has a memory 132 and may have a web portal 134 to facilitate operation and administration.

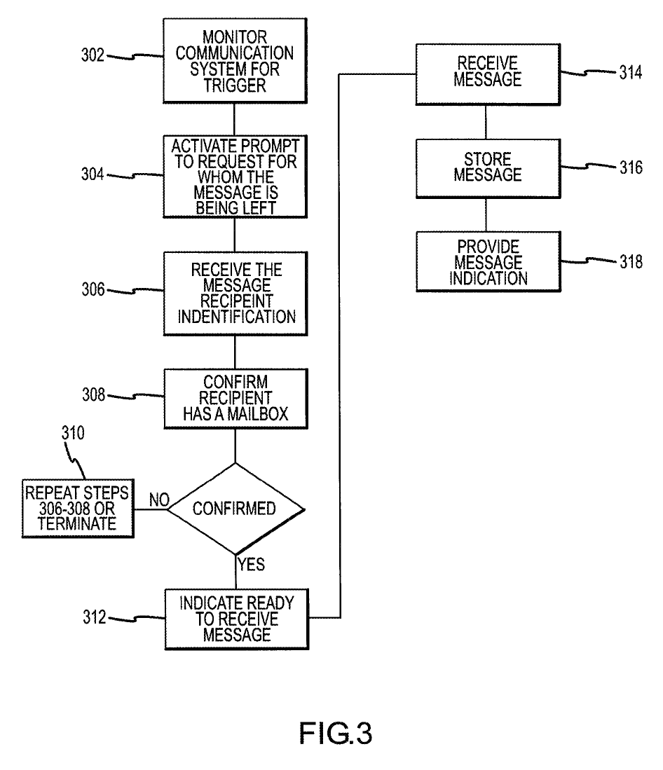

Referring now to FIG. 3, a flowchart 300 shows one methodology for operating system 100. First, system 100 would be enabled to monitor radio communications between mobile devices 102. Communication hub 108 would monitor the communications for particular trigger or hot word, such as for example, communication hub 108 may monitor for the verbal command “Leave Message,” step 302. Alternatively, the system may wait for a key command, such as a prolonged push on the talk control or the like. When communication hub 108 recognizes the trigger, system 100 activates and prompts the messaging party to indicate for which system user a message is to be left, step 304. The calling party indicates the called party by, for example, stating “John Johnston,” step 306, and communication hub 108 confirms the called party is part of the network, step 308. If communication hub 108 cannot confirm the called party, the calling party can try again, the communication hub can reply with a suitable non-recognition response, or the like, step 310. If recognized, communication hub 108 delivers a ready for message signal to the calling party, such as, leave your message for Mr. Johnson now, a tone signal, or the like, step 312. The calling party speaks the message, step 314, that is stored in an appropriate location or mailbox in memory 118, step 316. The data stored in memory 118 can be voice records, text message records, image records, video records, audio/video records or the like. Further, date and time stamps may be included on the message recording. Also, many radio networks only allow specified uses, thus, system 100 may confirm the identity of the person leaving the message as an optional choice. Moreover, if mobile devices are capable of sending other media, such as, for example, still images or video, memory 118 can store those as well.

Optionally, when a message is saved in memory 118, system 100 may notify uses of the radio network that messages are saved, step 318. Because radio networks are typically used by a number of users, a tone or the like on the radio channel is a possible but unsatisfactory solution because it does not identify which user has a message to retrieve. Thus, preferably, system 100 compiles a list of users associated with the channel that have messages to be retrieved and periodically broadcasts to the users those users with messages. For example, every 10 minutes, system 100 may broadcast, a voice signal stating something like: “Messages available for Mr. Johnson, Mr. Smith, Mr. Roe, Mr. Doe.” Other signals could also be used. Because many users leave messages in memory, it is preferable for system 100 to only broadcast when Mr. Johnson, for example, has a new, un-reviewed message.

Alternative, optional, or in addition to, system 100 could broadcast when each new message is input to the system. For example, after a predetermined amount of time, system 100 may broadcast, Mr. Johnson has a new message. Also, system 100 may be connected to a conventional telephone system through interface 112. System 100 could provide a signal over the conventional telephone system to Mr. Johnson's telephone that a message exists in the radio network memory. Also, system 100 could indicate Mr. Johnson has a message through an email, text message or the like over network connection 130 and/or web portal 134.

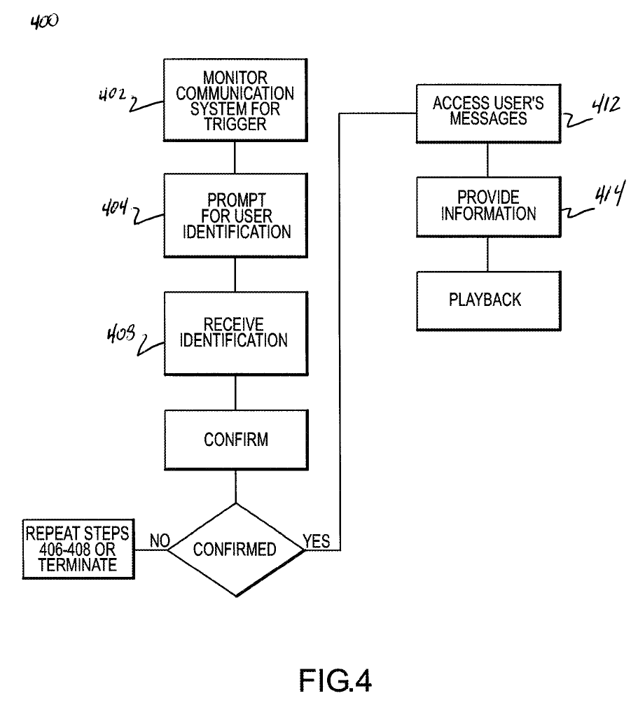

If a party receives a message notification, or simply wishes to check whether they have messages while using one of mobile devices 104, the user provides a trigger to activate system the message system. Referring to FIG. 4, a flowchart 400 of one possible way to retrieve messages from system 100 is provided. First, system 100 monitors the communication for a trigger, step 402. The trigger could be a voice command, such as, for example, “get messages,” a key command, or the like step 402. Alternatively, the trigger could be received when a user connects to the communication hub via telephony interface 112. Once activated, the system prompts the party for a name or system identifier, step 404. The party states the identification step 406, and the system then confirms the user, step 408. Additional security measures could include voiceprint authentication, user security words, password codes, or the like. If the system does not recognize the user name, the system could prompt for the party to restate the identification and/or provide a fault indication.

Once authenticated, the system accesses memory 118, step 412, and optionally provides information to the party, such as, the number of stored messages, number of new messages, number of old messages, or the like, step 414. The system then provides a playback of the messages in memory 118. During the playback, or at specific intervals such as after a message, the system monitors for particular commands from the party, such as, for example, reply, delete, skip, store, repeat, advance, rewind, or the like. These commands are similar to conventional voicemail system commands.

If the party attempts an unrecognized command, either not an authorized action or the command is simply not understood, the system will either ignore the command or request the command be repeated. Further, the system may provide a list of appropriate commands at particular times, such as, for example, when a command is unrecognized, at the end of a message or messages, or when requested. Failure to respond to a command request should be a time out sequence after which the review message command will be cancelled and the system reset.

Some radio systems include enhanced user identification. For example, some radio networks use signaling protocols to identify particular radios, such as Motorola Data Communications (“MDC”) signaling or the like. Frequently, in these systems, each radio is identified with a particular user or user group. When this is the case, the radio network can identify the calling party and the called party without input from either party. Thus, the radio network could, for example, respond to the Leave Message command with a statement such as: “Who would you like to leave a message for?” Further, if Mr. Johnson left a message for Mr. Smith, the system could send a particular radio signal received and used only by Mr. Smith's radio. The signal could, for example, provide a signal indication on the radio that Mr. Smith has a new message. Finally, when Mr. Smith provided the Get Message command, the system could automatically retrieve Mr. Smith's messages and/or prompt Mr. Smith for the appropriate identification, such as, please confirm you are Mr. Smith, or Mr. Smith please provide your password, or the like.

As shown, system 100 can support a predefined number of users and/or mailboxes. The number is scalable depending largely on the memory and the processors ability to manage the system. Users can be increased by increasing memory and/or decreasing the amount of memory allocated to each mailbox. The mailboxes may be further subdivided into a particular amount of memory for each message, or a limit on the maximum storage capability, etc. Generally, the administration of the system is similar to telephony voicemail systems.

Memory and/or mailboxes may be associated with particular radios. In such cases, especially when a user is assigned a particular radio, the memory location or mailbox may be associated with a unique radio identification. The radio identification may include indication of whether signaling protocols are available, such as, MDC or the like. Signaling protocols may allow additional, and generally optional, features and programs to be activated. For example, if signaling protocols are available, particular mobile device message or mail notification may be set. The message notification may be a light activation (visual, audible, or the like) on the mobile device, a message on a display on the mobile device (such as number of new messages), a sound every predefined number of seconds (such as a beep every 10 seconds), a combination thereof, or the like. Moreover, if the mobile device is connected to a vehicle, the system may caused the vehicle to sound a horn, blink the vehicle lights, or the like.

Access to the messages will also be provided via a telephone interface as described above. The telephone access would be similar to the access described above for radio access, and will not be further described herein. Network access may similarly be available as a matter of design choice.

While the invention has been particularly shown and described with reference to an embodiment thereof, it will be understood by those skilled in the art that various other changes in the form and details may be made without departing from the spirit and scope of the invention.

1. A method to leave a voice message on a radio network, the method comprising the steps of:
providing an activation signal to a communication hub of a desire of a first user to leave a message for a second user;
indicating to the first user that the communication hub is ready to receive the message;
providing the message to the communication hub for storage; and
storing the message for retrieval by the second user.

2. The method of claim 1, further comprising the step of monitoring the radio network for the activation signal.

3. The method of claim 1, wherein the step of providing the activation signal comprises speaking.

4. The method of claim 1, wherein the step of indicating to the first user that the communication hub is ready to receive the message comprises the steps of:
requesting an identification of the second user; and
confirming the second user is a member of the radio network.

5. The method of claim 1, further comprising the steps of:
identifying the first user; and
confirming the first user is authorized to leave messages on the radio network.

6. The method of claim 1, further comprising the step of:
broadcasting an indication over the radio network that at least one message is stored.

7. The method of claim 6, wherein the step of broadcasting an indication comprises a signal that the second user has at least one message.

8. The method of claim 1, wherein the message comprises data selected from the group of data consisting of: voice data, text data, image data, video data, or audio/video data.

9. A method to retrieve a voice message on a radio network, the method comprising the steps of:
providing an activation signal to a communication system for a user to retrieve messages;
identifying the user;
accessing the mail box of the user; and
delivering the messages.

10. The method of claim 9, further comprising the step of providing information regarding the messages to the user.

11. The method of claim 9, wherein the step of delivering the messages includes responding to verbal commands.

12. The method of claim 11, wherein the verbal commands are selected from a group of message navigation and message management commands consisting of: play, rewind, fast forward, skip, delete, or save.

13. The method of claim 9, further comprising the step of monitoring the radio network for the activation signal.

14. The method of claim 9, further comprising the step of connecting to the communication hub through a telephony interface.

15. An apparatus to allow users of a radio network to leave messages for other users of the radio network, the apparatus comprising:
a radio gateway;
a communication hub, the communication hub to connect to a radio network through the radio gate;
the communication hub comprising a voice enabled speech platform for receiving and transmitting messages, and a memory for storing messages from users to other users; wherein
the communication hub monitors the radio network for an activation signal and receives, transmits, or stores messages after recite of the activation signal.

16. The apparatus of claim 15, further comprising a telephony interface to couple the communication hub to a telephone.

17. A computer program product comprising:
a computer usable medium having computer readable code embodied therein for receiving, transmitting, and storing voice messages between users of a radio network, the computer usable medium comprising:
a recording and playback module configured to record and playback messages;
an activation module configured to receive and recognize an activation signal;
an indicating module configured to indicate that recording and playback module is ready to record or playback the message, wherein
the activation module causes the indicating module to indicate when the activation signal is received and recognize; and
a memory module configured to store messages.

18. The computer program product of claim 17, wherein the activation module is further configured to monitor the radio network for the activation signal.

19. The computer program product of claim 17, wherein recording and playback module is further configured to respond to commands.

20. The computer program product of claim 17, further comprising a confirmation module configured to confirm the identity of at least one user when recording or playing back messages.

21. The method of claim 1, wherein the communication hub is provided at a centralized location.

22. The method of claim 9, further comprising the step of confirming the user identification.

23. The method of claim 9, further comprising the step of providing a signal to emulate the pushing of the talk button on a mobile device on the radio network.

24. The method of claim 9, further comprising the step of determining whether the talk button is pushed on at least one mobile device associated with the radio network and transmitting messages if no talk buttons are pushed.

25. The method of claim 9, further comprising retrieving messages via a web portal.

26. The method of claim 9, further comprising administering the communication hub via a web portal.
